(19) United States
(12) Patent Application Publication
(10) Pub. No.: US 2013/0268414 A1
(43) Pub. Date: Oct. 10, 2013

(54) METHOD AND APPARATUS FOR PROVIDING SERVICES USING CONNECTING USER INTERFACE ELEMENTS

(71) Applicants: Arto Juhani Lehtiniemi, Lempaala (FI); Juha Henrik Arrasvuori, Tampere (FI); Antti Johannes Eronen, Tampere (FI)

(72) Inventors: Arto Juhani Lehtiniemi, Lempaala (FI); Juha Henrik Arrasvuori, Tampere (FI); Antti Johannes Eronen, Tampere (FI)

(73) Assignee: Nokia Corporation, Espoo (FI)

(21) Appl. No.: 13/443,360

(22) Filed: Apr. 10, 2012

(51) Int. Cl. G06F 3/048; G06Q 30/06

(52) U.S. Cl. 705/27.2; 715/846

(57) ABSTRACT

An approach is provided for providing services using connecting user interface elements. The connector platform determines one or more functions, one or more properties, or a combination thereof associated with one or more services. Next, the connector platform causes, at least in part, a rendering of at least one connecting user interface element to represent the one or more functions, the one or more properties, or a combination thereof. Then, the connector platform processes and/or facilitates a processing of one or more interactions between the at least one connecting user interface element and one or more service user interface elements to determine whether to enable the one or more functions, the one or more properties, or a combination thereof.

### BACKGROUND

Service providers and device manufacturers (e.g., wireless, cellular, etc.) are continually challenged to deliver value and convenience to consumers by, for example, providing compelling network services with various functions and properties. These services may, for instance, be offered through any number of users devices, such as desktops, notebooks, tablets, mobile phones, automobiles, appliances, etc. Nonetheless, service providers and device manufacturers must continue to differentiate their services and technologies to stay competitive. One approach may, for instance, include developing new ways of enabling such services, the functions and properties of those services, etc. Other approaches include new ways of purchasing or subscribing to services having different functions and properties along with new ways of adding additional functionalities and enhanced properties to those services.

### SOME EXAMPLE EMBODIMENTS

Therefore, there is a need for an approach for providing services using connecting user interface elements.

According to one embodiment, a method comprises determining one or more functions, one or more properties, or a combination thereof associated with one or more services. The method also comprises causing, at least in part, a rendering of at least one connecting user interface element to represent the one or more functions, the one or more properties, or a combination thereof. The method further comprises processing and/or facilitating a processing of one or more interactions between the at least one connecting user interface element and one or more service user interface elements to determine whether to enable the one or more functions, the one or more properties, or a combination thereof.

According to another embodiment, an apparatus comprises at least one processor, and at least one memory including computer program code for one or more computer programs, the at least one memory and the computer program code configured to, with the at least one processor, cause, at least in part, the apparatus to determine one or more functions, one or more properties, or a combination thereof associated with one or more services. The apparatus is also caused to cause, at least in part, a rendering of at least one connecting user interface element to represent the one or more functions, the one or more properties, or a combination thereof. The apparatus is further caused to process and/or facilitate a processing of one or more interactions between the at least one connecting user interface element and one or more service user interface elements to determine whether to enable the one or more functions, the one or more properties, or a combination thereof.

According to another embodiment, a computer-readable storage medium carries one or more sequences of one or more instructions which, when executed by one or more processors, cause, at least in part, an apparatus to determine one or more functions, one or more properties, or a combination thereof associated with one or more services. The apparatus is also caused to cause, at least in part, a rendering of at least one connecting user interface element to represent the one or more functions, the one or more properties, or a combination thereof. The apparatus is further caused to process and/or facilitate a processing of one or more interactions between the at least one connecting user interface element and one or more service user interface elements to determine whether to enable the one or more functions, the one or more properties, or a combination thereof.

According to another embodiment, an apparatus comprises means for determine one or more functions, one or more properties, or a combination thereof associated with one or more services. The apparatus also comprises means for causing, at least in part, a rendering of at least one connecting user interface element to represent the one or more functions, the one or more properties, or a combination thereof. The apparatus further comprises means for processing and/or facilitating a processing of one or more interactions between the at least one connecting user interface element and one or more service user interface elements to determine whether to enable the one or more functions, the one or more properties, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing services using connecting user interface elements, according to one embodiment;

FIG. 2 is a diagram of the components of a connector platform, according to one embodiment;

FIG. 3 is a flowchart of a process for providing services using connecting user interface elements, according to one embodiment;

FIG. 4 is a flowchart of a process for selecting a connecting user interface element from a set of connecting user interface elements, according to one embodiment;

FIG. 5 is a flowchart of a process for initiating services with certain functions and/or properties, according to one embodiment;

FIG. 6 is a flowchart of a process for initiating actions associated with connecting user interface element leaks, according to one embodiment;

FIGS. 7A-7C are diagrams of connecting user interface elements, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for providing services using connecting user interface elements are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

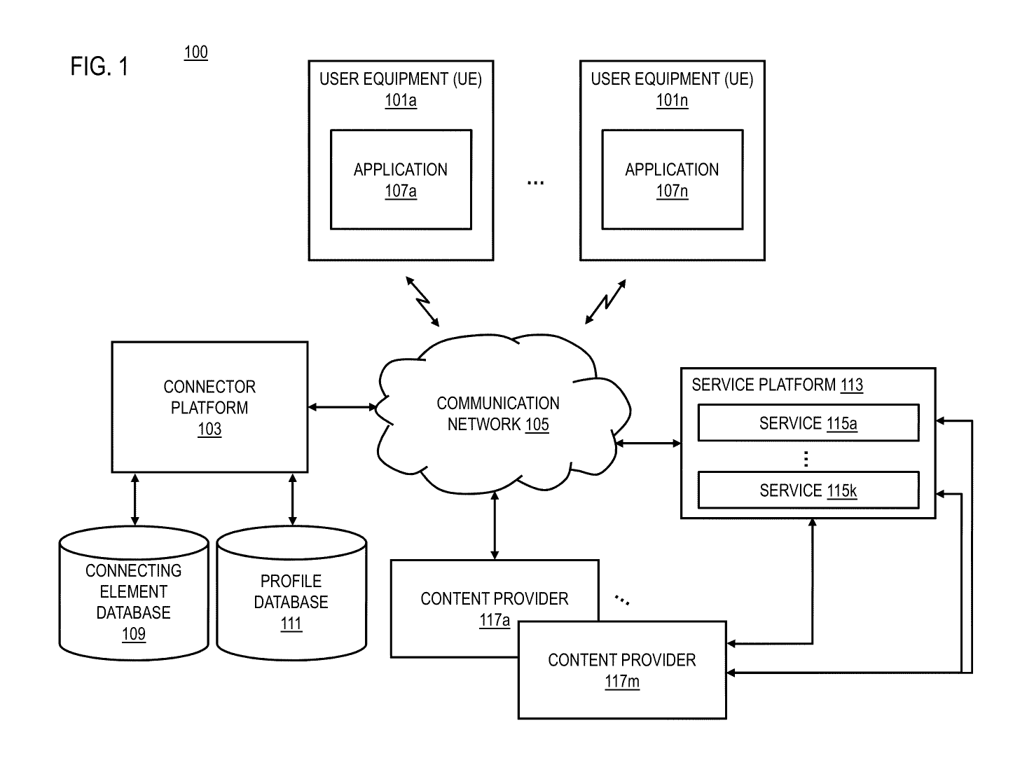

FIG. 1 is a diagram of a system capable of providing services using connecting user interface elements, according to one embodiment. As discussed, service providers and device manufacturers must continue to differentiate their services and technologies to stay competitive. Challenges may, for instance, include developing new ways of enabling such services, the functions and properties of those services, etc., and new ways of purchasing or subscribing to services having different functions and properties, adding additional functionalities and enhanced properties to those services, etc.

To address these challenges, a system 100 of FIG. 1 introduces the capability to provide services using connecting user interface elements. By way of example, the system 100 may determine functions and/or properties of a service, and then render a connecting user interface element to represent the functions and/or the properties. The system 100 may thereafter process interactions between the connecting user interface element and service user interface elements to determine whether to enable the functions and/or the properties. In one scenario, a user may log into a media service to obtain a virtual cable that may be utilized to enable certain functions and/or properties of the media service. Upon logging in, the user may be presented with a variety of virtual cables for accessing different functions and/or properties of the media service. Moreover, the virtual cables may vary in appearance since the virtual cables may respectively have different user interface characteristics that represent the various service functions and/or properties that the virtual cables may enable. The user may, for instance, drag one end of a particular cable to a media streaming module to establish a connection offering high bitrate music. When the virtual cable is attached to the media streaming module, the system 100 may inspect the virtual cable to determine the functions (e.g., media streaming) and the properties (e.g., high bitrate) that the virtual cable is associated with. The system 100 may then establish the service connection based on such determination.

In another scenario, a user may sign up for a free trial. As such, he may only be able to utilize special trial cables. For example, the user may be able to create playlists by patching the trial cables to various service user interface elements (e.g., creating a mixed playlist by patching songs from a number of location-based playlists depicted as elements on the user interface). However, due to the use of trial cables (e.g., as opposed to non-trial cables), the user may be restricted to an hour of listening time with respect to music from playlists that he created, playlists offered by the various service user interface elements, etc. In addition, the remaining time may be visible on the rendering of the trial cables, for instance, where the color fill of the cable tip will display the remaining time as a progress bar or as a virtual fuse burning across the outer shell of the cable between its two ends (or deteriorating in some other way) to indicate the remaining trial time. In some embodiments, the tips of the trial cables may be slightly larger than non-trial cables, and the trial cable tips may not fit all of the service user interface elements (e.g., the trial cable tips may not be compatible with the input/output connectors of some of the service user interface elements). As such, the user may not be able to access some of the functions and/or properties of services associated with the non-compatible service user interface elements, including sharing of the playlist to the user's social networking group, saving of the playlist for later convenience, etc.

In yet another scenario, the user may want to share his “Greatest Love Songs” playlist to his closest friends in a gaming environment. However, the user may not want anyone else to be able to listen to this particular playlist. As such, the user may select a special type of sharing cable and then connect the cable to the output of the playlist and the inputs of his closest friends depicted on the user interface. Thus, only his closest friends are able to listen to this playlist. In this way, the system 100 provides a new approach to providing services, for instance, using connecting user interface elements to enable functions and/or properties of such services. It is noted that although various embodiments are described with respect to music, it is contemplated that the approach described herein may be used with other audio types (e.g., audio books, voice recordings, etc.), other media types (e.g., images, videos, etc.), and other content types.

As shown in FIG. 1, the system 100 comprises a user equipment (UE) 101 (or multiple UEs 101a-101n) having connectivity to a connector platform 103 via a communication network 105. The UE 101 may include or have access to an application 107 (e.g., applications 107a-107n) to enable the UE 101 to interact with, for instance, the connector platform 103, which may: (1) determine functions and/or properties of one or more services; (2) render a connecting user interface element to represent the functions and/or the properties; (3) process interactions between the connecting user interface element and service user interface elements to determine whether to enable the functions and/or the properties; (4) select the connecting user interface element from a set of connecting user interface elements (e.g., based on purchases and/or subscriptions of users) respectively having various user interface characteristics for representing certain functions and/or properties of the one or more services; (5) initiate the one or more services with the functions and/or the properties based on a connecting of the connecting user interface element to at least one of the service user interface elements; (6) render a leak associated with the connecting user interface element based on content consumed in proximity to a point of interest associated with the service user interface element (e.g., to depict one or more recommendations associated with the content consumed); or (7) perform other functions.

In various embodiments, the connector platform 103 may include or have access to a connecting element database 109 to access or store connecting user interface elements, information associated with the connecting user interface elements, etc. The connector platform 103 may also include or have access to a profile database 111 to access or store service profiles describing functions, properties, and other information associated with various services, user account information including subscribed services, purchased/downloaded connecting user interface elements, utilization and/or consumption data (e.g., services utilized, content items consumed, locations associated with the consumption, etc.), etc. Data stored in the connecting element database 109 and the profile database 111 may, for instance, be provided by the UEs 101, a service platform 113, one or more services 115 (or services 115a-115k), one or more content providers 117 (or content providers 117a-117m), and/or other services available over the communication network 105. For example, a certain service 115 may provide various connecting user interface elements to access that service 115. It is noted that the connector platform 103 may be a separate entity of the system 100, a part of the one or more services 115 of the service platform 113, or included within the UE 101 (e.g., as part of the application 107).

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In another embodiment, the connector platform 103 may cause, at least in part, a selection of the at least one connecting user interface element from a set of connecting user interface elements that includes, at least in part, the at least one connecting user interface element and at least one other connecting user interface element. By way of example, the at least one connecting user interface element may have one or more user interface characteristics for representing the one or more functions, the one or more properties, or a combination thereof. In addition, the at least one other connecting user interface element may have one or more other user interface characteristics for representing one or more other functions, one or more other properties, or a combination thereof associated with the one or more services, one or more other services, or a combination thereof.

In one scenario, users may utilize a service that allow them to “conquer” points of interest (e.g., territories, areas, regions, places, etc.), for instance, by listening to music using certain virtual cables while in proximity to a point of interest that they wish to conquer (e.g., users may conquer an area if they listen to more music in that area than other users in that area). To encourage users to participate, trial subscriptions for the service may be offered. When a user registers for a trial subscription, the service may provide the user with a trial cable selected from a set of trial and non-trial cables associated with the service. Trial cables may, for instance, feature a number of characteristics that depart from non-trial cables to distinguish the trial cables from the non-trial cables. As an example, the trial cable may display a counter related to the number of plays that the user has left in the trial subscription. Each time the user plays music by connecting the trial cable to a service user interface element associated with the service, the visualization of the counter on the trial cable may be decremented by one to inform the user how many plays are left in the trial subscription. When the counter reaches the zero value, the service may stop the playback and send a message to the user to upgrade his subscription.

In another scenario, users may conquer points of interest as a team. Moreover, each team may have their own appearance of virtual cables to promote their visibility in the service. When an area is conquered by a team member, the characteristics of the virtual cables may, for instance, be displayed on the representation of the area rendered on the user interface (e.g., of all the participating users) to indicate that the team has conquered the area. In yet another scenario, the set of virtual cables for the service may include a number of cables associated with various audio qualities. Trial users may, for instance, be provided with basic grey cables that supply music with bitrates of up to 96 kbps (kilobits per second), and premium users may be provided with golden cables that supply music with bitrates of up to 320 Kbps. In addition, users may upgrade their virtual cables to platinum cables that offer lossless tracks along with high priority to service bandwidth.

In another embodiment, the connector platform 103 may determine one or more purchases, one or more subscriptions, or a combination thereof associated with one or more users, wherein the selection is further based, at least in part, on the one or more purchases, the one or more subscriptions, or a combination thereof. As discussed, in one use case, a service may offer trial subscriptions to encourage users to try out the service. When the service detects a new trial subscription, it may, for instance, select a virtual cable for enabling trial functions and/or properties of the service from a set of trial cables. In some cases, the service may provide the user with a set of trial cables, where each of the trial cables may enable a different set of trial functions and/or properties associated with the service. A trial cable associated with a lower purchase price may, for instance, offer less trial functions, while a trial cable associated with a higher purchase price may offer more trial functions.

In another scenario, a user may register to a service and purchase one or more cables of a certain type. Thereafter, the user may select a purchased cable to establish a connection, for instance, between two points of interest on the user interface, between an existing playlist and a sharing module, etc. The service may then compare the cable type against the allowed types for the requested connection. For example, each module associated with the service may have a listing of the allowed cable types which can access the module. Moreover, cables may be given a grade based on prices from 1 to 10, where 1 is the least expensive and 10 is the most expensive. A certain sharing module may, for instance, have a rule that only allow connections made with cables of categories 5 or higher. Thus, if the cable type used to make the connection is within the allowed types of the connection, the service will establish the connection. Otherwise, the service may transmit an error message to the user, requesting that the user buy a suitable cable to enable the connection.

In another embodiment, the connector platform 103 may cause, at least in part, an initiation of the one or more services with the one or more functions, the one or more properties, or a combination thereof based, at least in part, on a determination to enable the one or more functions, the one or more properties, or a combination thereof. In certain embodiments, the connector platform 103 may determine that the one or more interactions include, at least in part, a connecting of the at least one connecting user interface element to at least one of the one or more service user interface elements, wherein the determination to enable may be based, at least in part, on the connecting of the at least one connecting user interface element to the at least one service user interface element. In further embodiments, the connecting of the at least one connecting user interface element to at least one service user interface element may be based, at least in part, on a determination that the at least one connecting user interface element is compatible with the at least one service user interface element.

By way of example, the tips of virtual cables may be of different sizes and shapes. Moreover, service user interface elements (e.g., filters, modules, etc.) on the user interface may also have input/output connectors that are of different sizes and shapes. Thus, cable tips of one size and shape may not fit input/output connectors of the service user interface elements that are of a different size and shape. In one use case, content sharing may not be enabled for trial users of a particular service. As a result, the tips of trial cables may not fit the input/output connectors of content sharing modules associated with the service. As such, if a user tries to connect a trial cable to a content sharing module, the user may be prompted with a message that the trial cable is not compatible with the content sharing module. In another use case, a particular user interface environment may be shared by numerous users. The user interface environment may include a content storage module that stores restricted files associated with a particular group. However, in order to have access to the restricted files, a user must utilize an appropriate cable with a tip that matches the input/output connector of the content storage module. In this way, the restricted files may be protected from other users without the appropriate cable even though the content sharing module is left on the user interface environment that is accessible by those other users.

In some embodiments, the cable could have more than one tip at its ends. In one embodiment, the user may make a connection with more than one cable to create a combined cable which enables a different set of services than either of the cables alone. For example, the user could have an audio cable and a visual-content-only cable, and combining them would create an audio-visual cable to allow video playback.

In some embodiments, a controller element may be inserted at a point along the cable. The controller element may be visualized, for instance, as a clip that is attached to the cable. The controller element may accept input parameters, such as keywords or a dialer for setting a numerical value. The controller element may be used, for example, to adjust (e.g. reduce) the data rate passing through the cable, to filter out, or to highlight content matching certain keywords. The controller element may have a timer or clock functionality that, for instance, allows data to pass through the cable only for a given duration (e.g., it functions as an hourglass timer) or during a certain time of the day. The controller element may offer at least one connection to another virtual cable for relaying (e.g., copying or splitting) data through the other virtual cable. The controller element may also function as a lock that blocks data unless a correct password is entered on it. Another type of such a controller may, for instance, be a “karaoke filter” that would filter out the vocals from any song that passes through the cable. Such controller elements with many different functions may be included in the system. In some cases, multiple such controller elements may be attached onto one virtual cable.

In another embodiment, the connector platform 103 may determine one or more consumptions of one or more content items in proximity to at least one point of interest associated with the at least one service user interface element. In a further embodiment, the connector platform 103 may cause, at least in part, a rendering of at least one leak associated with the at least one connecting user interface element based, at least in part, on the one or more consumptions. By way of example, a service may track music consumption around one or more regions when users utilize the service's virtual cables to connect to those regions (e.g., to connect to location-based playlists associated with those regions) to listen to music. In one scenario, a virtual cables connected to a region may start leaking when the region gets “full” with consumptions (e.g., extensive music traffic around the region, many conquests of that region by users, etc.).

In another embodiment, the rendering of the at least one leak depicts, at least in part, one or more recommendations associated with the one or more content items. For example, when a virtual cable associated with a region starts leaking, recommendations of songs associated with the music consumption of that region (e.g., the most frequently played songs, the highest rated songs, etc.) may be presented in the rendering of the leak. If, for instance, the regions and the leak are rendered on a map user interface, the leak may recommend songs to the environment around the region, such as other territories, areas, regions, places, etc.

In another embodiment, the connector platform 103 may determine a combining, an overlapping, or a combination thereof of the at least one leak with at least one other leak associated with at least one other connecting user interface element. In a further embodiment, the connector platform 103 may cause, at least in part, at least one mix, at least one mashup, or a combination thereof of the one or more content items with one or more other content items associated with the at least one other leak. In one use case, a service may compare the number of connections to a region (e.g., one or more location-based playlists representing the region on a map user interface) whenever a user connects a virtual cable to that region. If, for instance, the number of connections exceeds a predetermined threshold of connections, the region may start to leak songs (e.g., recommended songs played around that region) from the virtual cables connected to that region. In addition, if the leak from that region starts to overlap with leaks from other regions, a new playlist may be created that includes a mix or a mashup of music from the overlapping leaks, from the various regions associated with the overlapping leaks, etc. Thus, the leaks may create cross-stylistic playlists from the various regions.

By way of example, the UE 101, the connector platform 103, the service platform 113, the services 115, and the content providers 117 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

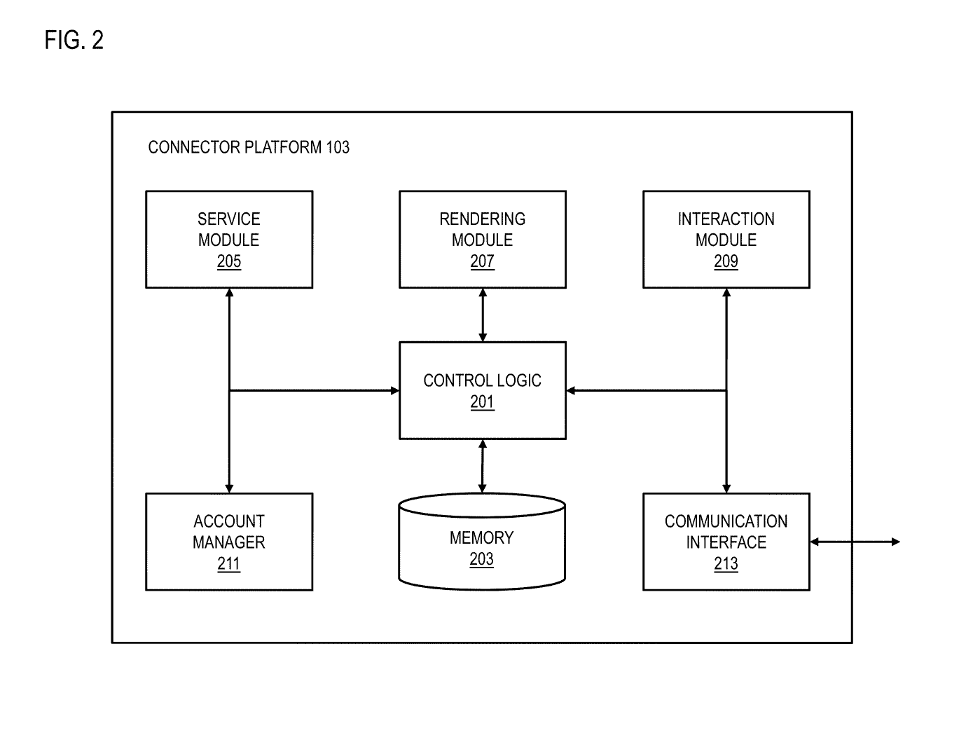

FIG. 2 is a diagram of the components of a connector platform, according to one embodiment. By way of example, the connector platform 103 includes one or more components for providing services using connecting user interface elements. It is contemplated that the functions of these components may be combined in one or more components or performed by other components of equivalent functionality. In this embodiment, the connector platform 103 includes a service module 205, a rendering module 207, an interaction module 209, an account manager 211, and a communication interface 213.

The control logic 201 executes at least one algorithm for executing functions of the connector platform 103. For example, the control logic 201 may interact with the service module 205 to determine functions and/or properties associated with a service (e.g., media streaming, the bitrate of the streamed media, etc.). The control logic 201 may also work with the rendering module 207 to render a connecting user interface element to represent the functions and/or the properties. As discussed, in certain embodiments, the connecting user interface element may be selected from a set of connecting user interface elements that includes the connecting user interface element along with other connecting user interface elements. The connecting user interface element may, for instance, have user interface characteristics for representing the functions and/or the properties, while the other user interface elements may have other user interface characteristics for representing other functions and/or other properties associated with the service and/or other services.

The control logic may also direct the interaction module 209 to process interactions between the connecting user interface element and service user interface elements to determine whether to enable the functions and/or the properties. As a result of the processing of the interactions, the interaction module 209 may, for instance, determine that the interactions include a connecting of the connecting user interface element with at least one of the service user interface elements. By way of example, the connecting of the connecting user interface element to the at least one service user interface element may be based on a determination that the connecting user interface element is compatible with the service user interface element (e.g., the tip of the connecting user interface element has a certain shape and size that fits the input/output terminals of the at least one service user interface element). Upon determining that the connection between the connecting user interface element and the at least one service user interface element has been established, the interaction module 209 may inform the service module 205 that the functions and/or the properties represented by the connecting user interface element should be enabled. Accordingly, the service module 205 may initiate the service with the functions and/or the properties.

In some embodiments, the control logic 201 may employ the account manager 211 to determine a purchase and/or a subscription associated with a user (e.g., based on a user account associated with the user), and to facilitate selection of the connecting user interface element from the set of connecting user interface elements based on the purchase and/or the subscription. In one scenario, the user may log into the service to purchase a virtual cable that can be used to enable certain functions and/or properties of the service, for instance, when the virtual cable is connected to an appropriate service user interface element. Once the purchase is acknowledged, the virtual cable may be associated with the user's account. As such, the user may have access to the virtual cable to enable the functions and/or the properties from a user device.

The control logic 201 may additionally utilize the communication interface 213 to communicate with other components of the connector platform 103, the UEs 101, the service platform 113, the services 115, the content providers 117, and other components of the system 100. For example, the communication interface 213 may be utilized to receive connection data (e.g., connections between connecting user interface elements and service user interface elements) along with consumption data from the UEs 101, the services 115, etc. The communication interface 213 may further include multiple means of communication. In one use case, the communication interface 213 may be able to communicate over short message service (SMS), multimedia messaging service (MMS), internet protocol, email, instant messaging, voice sessions (e.g., via a phone network), or other types of communication.

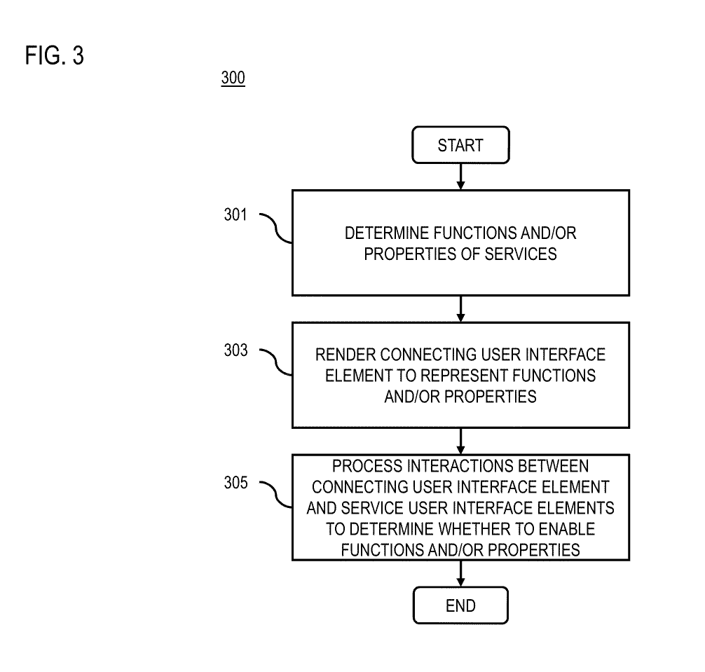

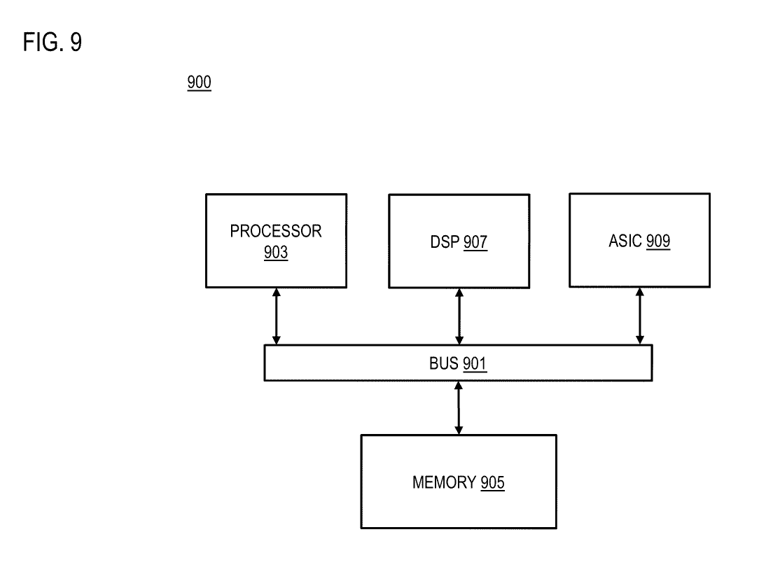

FIG. 3 is a flowchart of a process for providing services using connecting user interface elements, according to one embodiment. In one embodiment, the connector platform 103 performs the process 300 and is implemented in, for instance, a chip set including a processor and a memory as shown in FIG. 9. As such, the control logic 201 can provide means for accomplishing various parts of the process 300 as well as means for accomplishing other processes in conjunction with other components of the connector platform 103.

In step 301, the control logic 201 may determine one or more functions, one or more properties, or a combination thereof associated with one or more services. The control logic 201 may then, at step 303, cause a rendering of at least one connecting user interface element to represent the one or more functions, the one or more properties, or a combination thereof. By way of an example, a user may have a user account describing all of the services available to the user as well as the functions and/or the properties of those services that are available to the user. When the user logs into a particular service, the user account may be accessed to determine the functions and/or properties of the service that is available to the user. Based on this determination, one or more virtual cables may be rendered for the user to utilize to access the functions and/or properties of the service.

In step 305, the control logic 201 may process and/or facilitate a processing of one or more interactions between the at least one connecting user interface element and one or more service user interface elements to determine whether to enable the one or more functions, the one or more properties, or a combination thereof. The one or more service user interface elements may, for instance, be associated with the one or more services, one or more other services, etc.

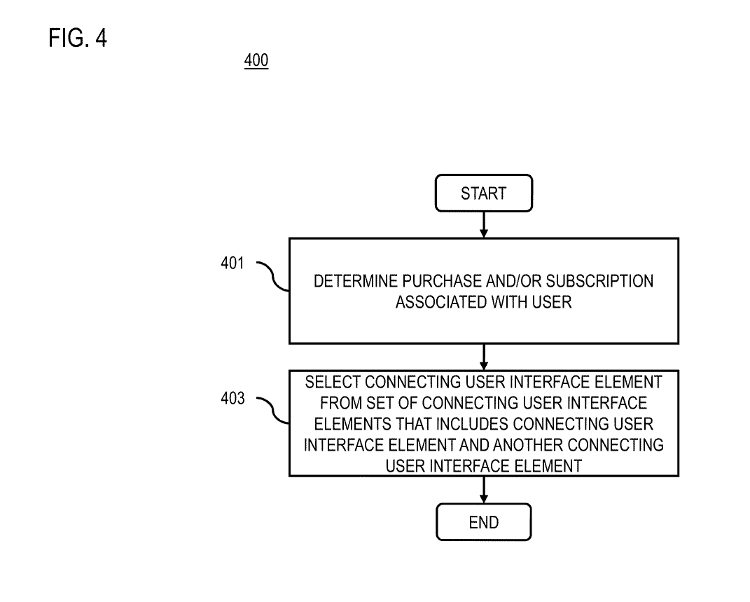

FIG. 4 is a flowchart of a process for selecting a connecting user interface element from a set of connecting user interface elements, according to one embodiment. In one embodiment, the connector platform 103 performs the process 400 and is implemented in, for instance, a chip set including a processor and a memory as shown in FIG. 9. As such, the control logic 201 can provide means for accomplishing various parts of the process 400 as well as means for accomplishing other processes in conjunction with other components of the connector platform 103.

In step 401, the control logic 201 may determine one or more purchases, one or more subscriptions, or a combination thereof associated with one or more users. As indicated, the purchases and/or the subscriptions may be for activating certain functions and/or properties of a service, to obtain virtual cables (e.g., or other types of connecting user interface elements) that can be used to enable those functions and/or properties, etc.

In step 403, the control logic 201 may cause a selection of the at least one connecting user interface element from a set of connecting user interface elements based on the one or more purchases, the one or more subscriptions, or a combination thereof. By way of example, the set may include the at least one connecting user interface element and at least one other connecting user interface element. The at least one connecting user interface element may, for instance, have one or more user interface characteristics for representing the one or more functions, the one or more properties, or a combination thereof. In addition, the at least one other connecting user interface element may have one or more other user interface characteristics for representing one or more other functions, one or more other properties, or a combination thereof associated with the one or more services, one or more other services, or a combination thereof. Accordingly, the appearances of the at least one connecting user interface element and the at least one other connecting user interface elements may differ from one another since the connecting user interface elements may represent different functions and/or properties of various services.

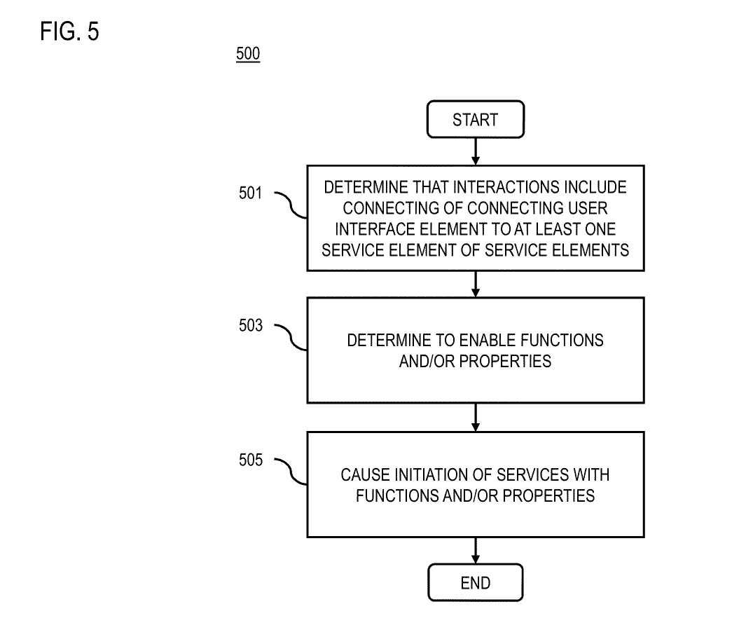

FIG. 5 is a flowchart of a process for initiating services with certain functions and/or properties, according to one embodiment. In one embodiment, the connector platform 103 performs the process 500 and is implemented in, for instance, a chip set including a processor and a memory as shown in FIG. 9. As such, the control logic 201 can provide means for accomplishing various parts of the process 500 as well as means for accomplishing other processes in conjunction with other components of the connector platform 103.

In step 501, the control logic 201 may determine that the one or more interactions include a connecting of the at least one connecting user interface element to at least one of the one or more service user interface elements. By way of example, the connecting of the at least one connecting user interface element to at least one service user interface element may be based on a determination that the at least one connecting user interface element is compatible with the at least one service user interface element. As indicated, in one use case, the tips of the connecting user interface elements (that represent functions and/or properties of the one or more services) may be of different sizes and shapes. In addition, the service user interface elements may have input/output connectors that are of different sizes and shapes. As such, in some embodiments, connecting user interface elements that have tips of one size and shape may not be compatible with service user interface elements that have tips of a different size and shape.

In response to the connecting of the at least one user interface element to the at least one service user interface element, the control logic 201 may, at step 503, determine to enable the one or more functions, the one or more properties, or a combination thereof. Thus, in step 505, the control logic 201 may cause an initiation of the one or more services with the one or more functions, the one or more properties, or a combination thereof.

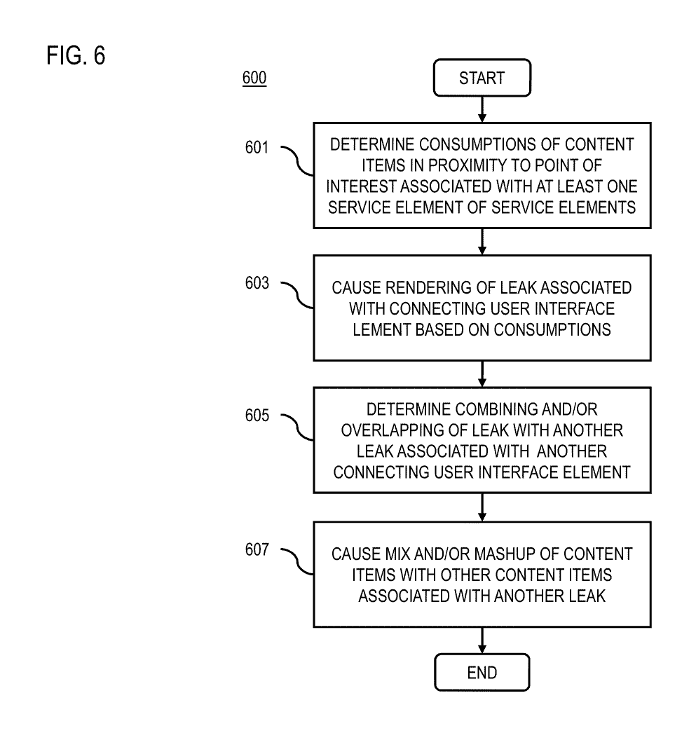

FIG. 6 is a flowchart of a process for initiating actions associated with connecting user interface element leaks, according to one embodiment. In one embodiment, the connector platform 103 performs the process 600 and is implemented in, for instance, a chip set including a processor and a memory as shown in FIG. 9. As such, the control logic 201 can provide means for accomplishing various parts of the process 600 as well as means for accomplishing other processes in conjunction with other components of the connector platform 103.

In step 601, the control logic 201 may determine one or more consumptions of one or more content items in proximity to at least one point of interest associated with the at least one service user interface element. In step 603, the control logic 201 may cause a rendering of at least one leak associated with the at least one connecting user interface element based on the one or more consumptions. In one scenario, for instance, a service may track media consumption around or within certain regions. One end of a virtual cable (e.g., the at least one connecting user interface element) may be connected to a depiction of the region on a map user interface (e.g., the depiction may be the at least one service user interface element). If, for instance, there are a lot of users listening to music in proximity to that region, the virtual cable may start to leak (e.g., because the amount of consumption in that region has exceed a predetermined threshold). As discussed, in certain embodiments, the rendering of the at least one leak may depict one or more recommendations associated with the one or more content items. Thus, in a further scenario, the rendered leak may depict recommended songs that were played in proximity to the region connected to the leaking virtual cable.

In step 605, the control logic 201 may determine a combining, an overlapping, or a combination thereof of the at least one leak with at least one other leak associated with at least one other connecting user interface element. For example, in the above scenario, other virtual cables connected to other depictions of other regions may start to leak as a result of media consumption exceeding a predetermined threshold of those other regions. The rendering of the various leaks associated with the different regions may start to overlap or combine with one another, and cause a mixture of the rendered leaks (e.g., overlapping yellow and blue leaks may result in a mixture having a green color).

In step 607, the control logic 201 may cause at least one mix, at least one mashup, or a combination thereof of the one or more content items with one or more other content items associated with the at least one other leak. By way of example, a virtual cable associated with one region may be leaking a rendering of blue fluid that contains recommended songs from that region. In addition, another virtual cable associated with another region may be leaking a rendering of a yellow fluid that contains recommended songs from that other region. When the blue and yellow fluids start to overlap with each other, a green mixture may result. The green mixture may, for instance, contain a mixture of the recommended songs, a mashup of the recommend songs, etc., from the blue and yellow fluids.

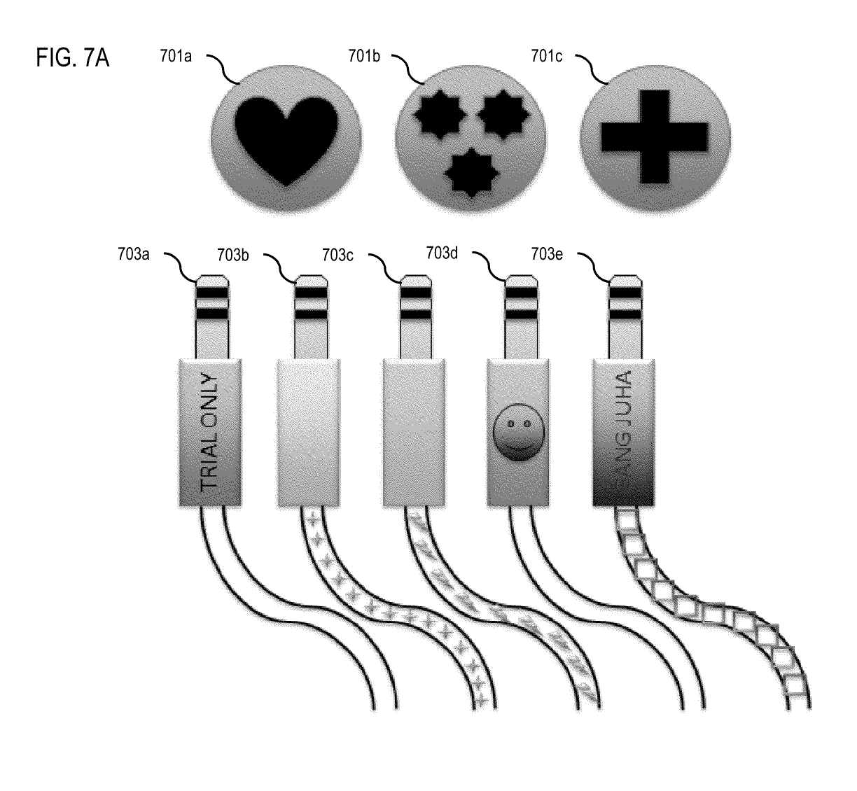

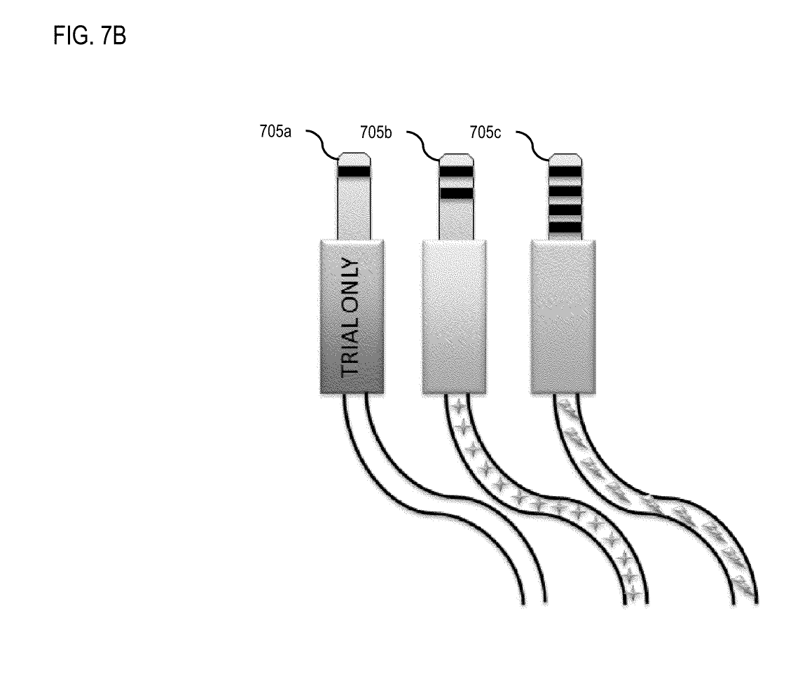

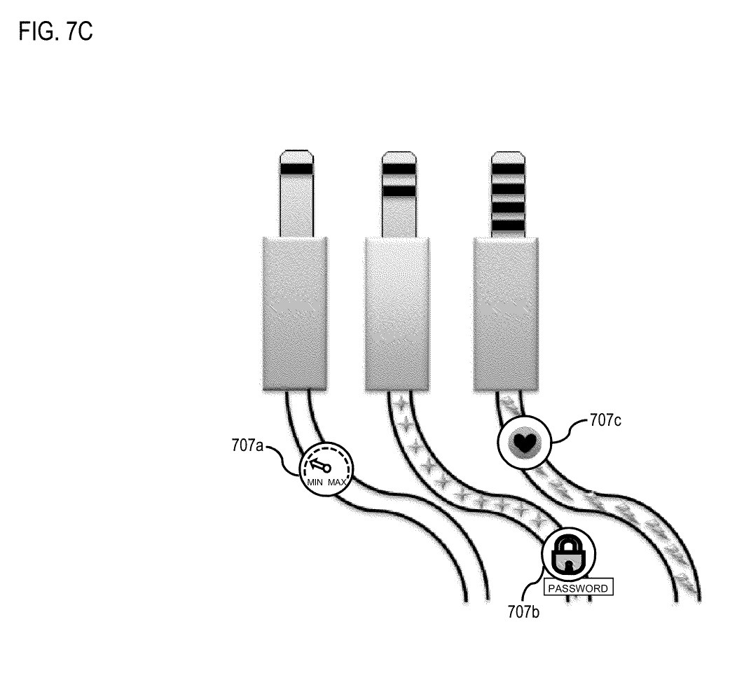

FIGS. 7A-7C are diagrams of connecting user interface elements, according to various embodiments. By way of example, FIG. 7A illustrates various connecting tips 701a-701c that may be associated with connecting user interface elements (e.g., connecting user interface elements 703a-703e). The connecting user interface elements (e.g., the virtual cables) may, for instance, have at least one wire part and at least one tip at the both ends of the wire part. As shown, the connecting tips 701a-701c are of different shapes and sizes (e.g., large heart shape, small octagon shapes, large cross shape, etc.). In one use case, for instance, connecting tip 701a may only connect with service user interface elements having input/output connectors with heart shapes of the appropriate size. In addition, as depicted, the connecting user interface elements 703a-703e have different user interface characteristics (e.g., in addition to the various shapes and sizes of the connecting tips). Furthermore, as illustrated, the outer shell of the wire part of the cable may present information statically or dynamically. For example, the shell of the wire part may present an animated summary of the data or media content that currently passes through it. Material for the summary may be obtained by sampling visual content (e.g., still images, videos, images from games, keywords from text, etc.) or by visualizing information (e.g., the animated waveform of audio).

FIG. 7B illustrates additional variations of the connecting user interface elements (e.g., connecting user interface elements 705a-705c). As indicated, different connecting user interface elements may represent different services as well as different functions and/or properties of those services. For example, different virtual cables connected to the same location-based playlist (e.g., a playlist associated with a particular point of interest) may provide streaming videos of various qualities, where the quality of the streaming video is based on the particular virtual cable that is used. As shown, connecting user interface elements 705a-705c have different connecting tips. Connecting user interface element 705a, for instance, has one stripe on its tip, while connecting user interface element 705b has two stripes on its tip and connecting user interface element 705c has four stripes on its tip. In one scenario, more stripes may indicate more audio channels that can be streamed (e.g., virtual stereo cable, virtual mono cable, virtual 5.1 surround sound cable, etc.). In another scenario, more stripes may indicate more dimensions in the media (e.g., mono, stereo, multi-channel, etc.) as well as more media types (e.g., audio, images, video, etc.).

FIG. 7C illustrates examples of controller elements 707a-707c connected to virtual cables (e.g., connecting user interface elements). As shown, the controller elements may be visualized as clips that are attached to the virtual cable. To give examples of some possible functions for the controller elements, element 707a is a dialer controller, element 707b is a lock that may be opened with a password, and element 707c is a connection to another virtual cable (e.g., with connecting tip type 701a).

The processes described herein for providing services using connecting user interface elements may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

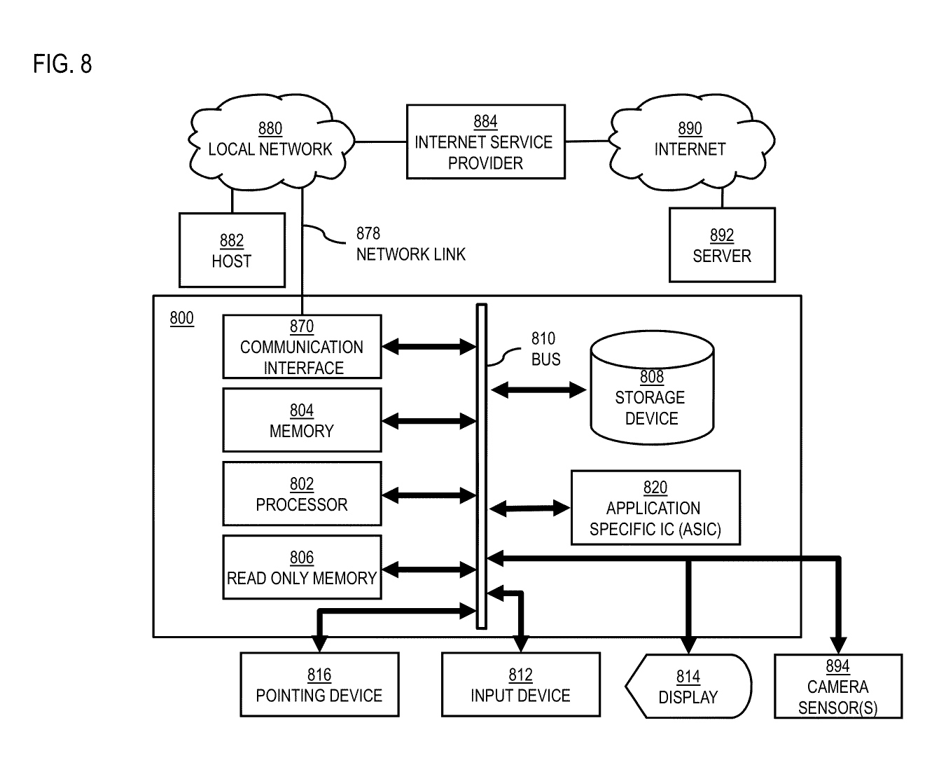

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to provide services using connecting user interface elements as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of providing services using connecting user interface elements.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to providing services using connecting user interface elements. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 800 also includes a memory 804 coupled to bus 810. The memory 804, such as a random access memory (RAM) or any other dynamic storage device, stores information including processor instructions for providing services using connecting user interface elements. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for providing services using connecting user interface elements, is provided to the bus 810 for use by the processor from an external input device 812, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814, and one or more camera sensors 894 for capturing, recording and causing to store one or more still and/or moving images (e.g., videos, movies, etc.) which also may comprise audio recordings. In some embodiments, for example, in embodiments in which the computer system 800 performs all functions automatically without human input, one or more of external input device 812, display device 814 and pointing device 816 may be omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for providing services using connecting user interface elements to the UE 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to provide services using connecting user interface elements as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of providing services using connecting user interface elements.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to provide services using connecting user interface elements. The memory 905 also stores the data associated with or generated by the execution of the inventive steps.

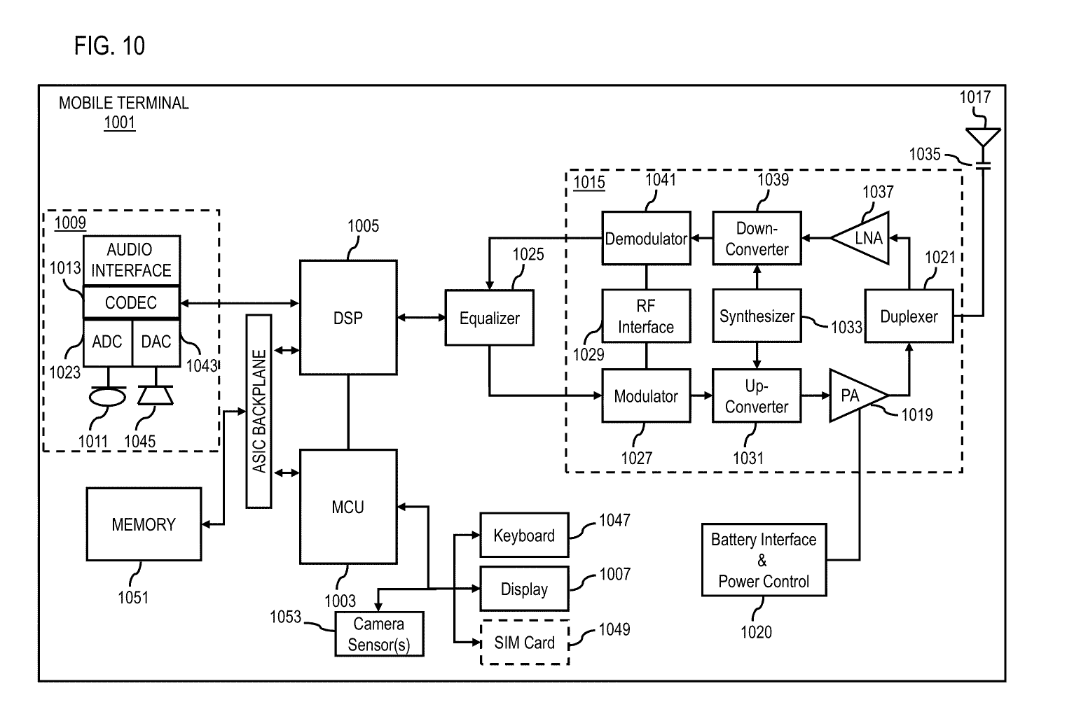

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of providing services using connecting user interface elements. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of providing services using connecting user interface elements. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to provide services using connecting user interface elements. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

Further, one or more camera sensors 1053 may be incorporated onto the mobile station 1001 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination of one or more functions, one or more properties, or a combination thereof associated with one or more services;
a rendering of at least one connecting user interface element to represent the one or more functions, the one or more properties, or a combination thereof; and
a processing of one or more interactions between the at least one connecting user interface element and one or more service user interface elements to determine whether to enable the one or more functions, the one or more properties, or a combination thereof.

2. A method of claim 1, wherein the (1) data and/or (2) information and/or (3) at least one signal are further based, at least in part, on the following:
a selection of the at least one connecting user interface element from a set of connecting user interface elements that includes, at least in part, the at least one connecting user interface element and at least one other connecting user interface element.

3. A method of claim 2, wherein the (1) data and/or (2) information and/or (3) at least one signal are further based, at least in part, on the following:
at least one determination of one or more purchases, one or more subscriptions, or a combination thereof associated with one or more users,
wherein the selection is based, at least in part, on the one or more purchases, the one or more subscriptions, or a combination thereof.

4. A method of claim 2, wherein the at least one connecting user interface element has one or more user interface characteristics for representing the one or more functions, the one or more properties, or a combination thereof, and wherein the at least one other connecting user interface element has one or more other user interface characteristics for representing one or more other functions, one or more other properties, or a combination thereof associated with the one or more services, one or more other services, or a combination thereof.

5. A method of claim 1, wherein the (1) data and/or (2) information and/or (3) at least one signal are further based, at least in part, on the following:
an initiation of the one or more services with the one or more functions, the one or more properties, or a combination thereof based, at least in part, on a determination to enable the one or more functions, the one or more properties, or a combination thereof.

6. A method of claim 5, wherein the (1) data and/or (2) information and/or (3) at least one signal are further based, at least in part, on the following:
at least one determination that the one or more interactions include, at least in part, a connecting of the at least one connecting user interface element to at least one of the one or more service user interface elements,
wherein the determination to enable is based, at least in part, on the connecting of the at least one connecting user interface element to the at least one service user interface element.

7. A method of claim 6, wherein the connecting of the at least one connecting user interface element to at least one service user interface element is based, at least in part, on a determination that the at least one connecting user interface element is compatible with the at least one service user interface element.

8. A method of claim 6, wherein the (1) data and/or (2) information and/or (3) at least one signal are further based, at least in part, on the following:
at least one determination of one or more consumptions of one or more content items in proximity to at least one point of interest associated with the at least one service user interface element; and
causing, at least in part, a rendering of at least one leak associated with the at least one connecting user interface element based, at least in part, on the one or more consumptions.

9. A method of claim 8, wherein the rendering of the at least one leak depicts, at least in part, one or more recommendations associated with the one or more content items.

10. A method of claim 8, wherein the (1) data and/or (2) information and/or (3) at least one signal are further based, at least in part, on the following:
at least one determination of a combining, an overlapping, or a combination thereof of the at least one leak with at least one other leak associated with at least one other connecting user interface element; and
at least one mix, at least one mashup, or a combination thereof of the one or more content items with one or more other content items associated with the at least one other leak.

11. An apparatus comprising:
at least one processor; and
at least one memory including computer program code for one or more programs, the at least one memory and the computer program code configured to, with the at least one processor, cause the apparatus to perform at least the following,
determine one or more functions, one or more properties, or a combination thereof associated with one or more services;
cause, at least in part, a rendering of at least one connecting user interface element to represent the one or more functions, the one or more properties, or a combination thereof; and
process and/or facilitate a processing of one or more interactions between the at least one connecting user interface element and one or more service user interface elements to determine whether to enable the one or more functions, the one or more properties, or a combination thereof.

12. An apparatus of claim 11, wherein the apparatus is further caused to:
cause, at least in part, a selection of the at least one connecting user interface element from a set of connecting user interface elements that includes, at least in part, the at least one connecting user interface element and at least one other connecting user interface element.

13. An apparatus of claim 12, wherein the apparatus is further caused to:
determine one or more purchases, one or more subscriptions, or a combination thereof associated with one or more users,
wherein the selection is based, at least in part, on the one or more purchases, the one or more subscriptions, or a combination thereof.

14. An apparatus of claim 12, wherein the at least one connecting user interface element has one or more user interface characteristics for representing the one or more functions, the one or more properties, or a combination thereof, and wherein the at least one other connecting user interface element has one or more other user interface characteristics for representing one or more other functions, one or more other properties, or a combination thereof associated with the one or more services, one or more other services, or a combination thereof.

15. An apparatus of claim 11, wherein the apparatus is further caused to:
cause, at least in part, an initiation of the one or more services with the one or more functions, the one or more properties, or a combination thereof based, at least in part, on a determination to enable the one or more functions, the one or more properties, or a combination thereof.

16. An method of claim 15, wherein the apparatus is further caused to:
determine that the one or more interactions include, at least in part, a connecting of the at least one connecting user interface element to at least one of the one or more service user interface elements,
wherein the determination to enable is based, at least in part, on the connecting of the at least one connecting user interface element to the at least one service user interface element.

17. An apparatus of claim 16, wherein the connecting of the at least one connecting user interface element to at least one service user interface element is based, at least in part, on a determination that the at least one connecting user interface element is compatible with the at least one service user interface element.

18. An apparatus of claim 16, wherein the apparatus is further caused to:
determine one or more consumptions of one or more content items in proximity to at least one point of interest associated with the at least one service user interface element; and
cause, at least in part, a rendering of at least one leak associated with the at least one connecting user interface element based, at least in part, on the one or more consumptions.

19. An apparatus of claim 18, wherein the rendering of the at least one leak depicts, at least in part, one or more recommendations associated with the one or more content items.

20. An apparatus of claim 18, wherein the apparatus is further caused to:
determine a combining, an overlapping, or a combination thereof of the at least one leak with at least one other leak associated with at least one other connecting user interface element; and
cause, at least in part, at least one mix, at least one mashup, or a combination thereof of the one or more content items with one or more other content items associated with the at least one other leak.

21-48. (canceled)
